(19) United States
(12) Patent Application Publication
(10) Pub. No.: US 2022/0342038 A1
(43) Pub. Date: Oct. 27, 2022

(54) DYNAMICALLY DETERMINING A TOWED TRAILER SIZE

(71) Applicant: Denso Corporation, Kariya-city (JP)

(72) Inventors: Eric James Armbruster, Plymouth, MI (US); Yasuyuki Miyake, Kariya-city (JP); Seiya Fujitsu, Kariya-city (JP)

(21) Appl. No.: 17/238,753

(22) Filed: Apr. 23, 2021

(51) Int. Cl. G01S 7/41; G01S 13/931

(52) U.S. Cl. CPC G01S 7/412; G01S 13/931; G01S 2013/93272; G01S 2013/9315

(57) ABSTRACT

Systems, methods, and other embodiments described herein relate to automatically determining the size of a trailer being towed by a vehicle. In one embodiment, a method includes, responsive to determining that a trailer is aligned with a towing vehicle, analyzing radar returns from a radar of the towing vehicle to identify radar features within an area behind the towing vehicle. The method includes determining a trailer size of the trailer from the radar features. The method includes adjusting operation of the towing vehicle according to the trailer size.

### TECHNICAL FIELD

The subject matter described herein relates in general to systems and methods for automatically determining the size of a trailer being towed by a vehicle and, more particularly, to using radar returns from a rear radar of the vehicle to estimate the size of the trailer.

### BACKGROUND

Towing a trailer with a vehicle can be a difficult task. For example, a trailer can induce instability in the vehicle under various circumstances (e.g., during strong braking events), and generally maneuvering a trailer can be complex, which may lead to collisions and other difficulties in navigating. Accordingly, vehicles often include various assistance systems to facilitate maneuvering and control when towing a trailer. As one example, a vehicle may include a blindspot monitoring system that informs an operator whenever an object is located within a blindspot of the towing vehicle. However, such assistance systems are generally configured for operation without a trailer and thus define functions according to the standard dimensions and characteristics of the vehicle without a trailer. To extend the functionality to situations when towing a trailer, the operator may manually modify the assistance systems by inputting trailer dimensions so that the assistance systems can better account for the presence of the trailer. However, accurately providing the size of the trailer may be difficult due to a lack of knowledge about the trailer and/or simply forgetting to alter the settings. Thus, the assistance systems may operate with incomplete or inaccurate data about the trailer, which may further complicate operation. For example, in the context of blindspot monitoring (BSM), the BSM system may fail to alert the operator about the presence of an object in a blindspot, which may lead to a collision in a worst case.

### SUMMARY

In one embodiment, example systems and methods associated with automatically determining the size of a trailer are disclosed. As previously noted, controlling and maneuvering a vehicle when towing a trailer can be a difficult task. Moreover, accurately reporting a trailer size to a vehicle assistance system so that the system can adapt operation to the presence of a trailer also presents particular difficulties.

Therefore, in one embodiment, a disclosed approach includes determining a trailer size for a trailer being towed by a towing vehicle using information from a radar of the towing vehicle. For example, in one arrangement, as the towing vehicle maneuvers, a trailer system determines the presence of a trailer and also when the towing vehicle and the trailer align. For the towing vehicle and the trailer to align, the trailer and the vehicle are in a substantially linear configuration. Thus, the trailer system may analyze dynamics and/or sensor data (e.g., rear images from a camera) to determine that the towing vehicle is progressing in a substantially straight line and the trailer and vehicle are in alignment.

The trailer system further acquires sensor data in the form of radar returns from at least one radar. The radar(s) are generally located on a rear section of the towing vehicle and observe an area behind the towing vehicle that is associated with the trailer. Accordingly, in one configuration, the trailer system generates a grid that is an abstraction of the area that is divided into a plurality of grid cells that separately correspond to a different portion of the area. The trailer system acquires the radar returns and generates the grid to identify characteristics of the radar returns associated with the separate grid cells. For example, the trailer system populates the grid with signal strength values for the different locations of the grid cells.

Thereafter, the trailer system can analyze the grid to identify radar features that correspond with aspects of the trailer, such as edges, physical features (e.g., reflectors, wheel cover, trailer axle), and so on. In at least one approach, analyzing the grid to identify the radar features includes identifying patterns associated with the edges, which may include valleys (i.e., reduced signal strengths) that extend linearly in a direction along the grid. Accordingly, the trailer system then determines the trailer size (e.g., length and width) according to locations of the radar features in the grid. The trailer system can then use the trailer size to adjust operation of the towing vehicle by, for example, changing a defined area of a blindspot that a blindspot monitoring system monitors along with determinations associated with safe lane changes, adapting stability controls, and so on. In this way, the trailer system improves determinations about trailer size and operation of the vehicle for associated systems.

In one embodiment, a trailer system is disclosed. The trailer system includes one or more processors and a memory that is communicably coupled to the one or more processors. The memory stores a control module including instructions that, when executed by the one or more processors, cause the one or more processors to, responsive to determining that a trailer is aligned with a towing vehicle, analyze radar returns from a radar of the towing vehicle to identify radar features within an area behind the towing vehicle. The control module includes instructions to determine a trailer size of the trailer from the radar features. The control module includes instructions to adjust operation of the towing vehicle according to the trailer size.

In one embodiment, a non-transitory computer-readable medium is disclosed. The computer-readable medium stores instructions that, when executed by one or more processors, cause the one or more processors to perform the disclosed functions. The instructions include instructions to, responsive to determining that a trailer is aligned with a towing vehicle, analyze radar returns from a radar of the towing vehicle to identify radar features within an area behind the towing vehicle. The instructions includes instructions to determine a trailer size of the trailer from the radar features. The instructions include instructions to adjust operation of the towing vehicle according to the trailer size.

In one embodiment, a method is disclosed. In one embodiment, a method includes, responsive to determining that a trailer is aligned with a towing vehicle, analyzing radar returns from a radar of the towing vehicle to identify radar features within an area behind the towing vehicle. The method includes determining a trailer size of the trailer from the radar features. The method includes adjusting operation of the towing vehicle according to the trailer size.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a configuration of a vehicle in which example systems and methods disclosed herein may operate.

FIG. 2 illustrates one embodiment of a trailer system that is associated with dynamically determining trailer size and adapting operation of a towing vehicle according to the trailer size.

FIG. 3 illustrates one example of a grid for determining trailer size.

FIG. 4 illustrates one embodiment of a method associated with dynamically determining trailer size.

FIG. 5 illustrates one example of a towing vehicle with a trailer.

FIG. 6 illustrates one example of monitoring areas for blindspot monitoring.

### DETAILED DESCRIPTION

Systems, methods, and other embodiments associated with automatically determining the size of a trailer are disclosed. As previously noted, controlling and maneuvering a vehicle when towing a trailer can be a difficult task. That is, visibility around a trailer can be difficult for an operator. Moreover, whereas a vehicle may have various assistance systems, such as blindspot monitoring, extending these systems to operate when a trailer is present can be tedious and relies on accurate manual entry of information by the operator, which is generally unreliable.

Therefore, in one embodiment, a disclosed approach includes automatically determining a trailer size for a trailer being towed by a towing vehicle using information from a radar of the towing vehicle. For example, in one arrangement, a trailer system determines the presence of a trailer and also when the towing vehicle and the trailer align. For the towing vehicle and the trailer to align, the trailer and the vehicle are in a substantially linear configuration (i.e., not turning or engaged in driving on curvy roads). Thus, the trailer system may analyze dynamics (e.g., steering information) and/or sensor data (e.g., rear images from a camera) to determine that the towing vehicle is progressing in a substantially straight line and the trailer and vehicle are in alignment. This configuration can ensure that the radar is directed at the trailer in a known position.

The trailer system acquires sensor data in the form of radar returns from at least one radar. The radar(s) are generally located on a rear section of the towing vehicle and observe at least an area behind the towing vehicle that is associated with the trailer. Accordingly, in one configuration, the trailer system generates a grid that is an abstraction of the area that is divided into a plurality of grid cells that separately correspond to different sections of the area. The trailer system can then use the grid to assess the radar returns associated with different locations. The trailer system acquires the radar returns and generates the grid to identify characteristics of the radar returns associated with the separate grid cells. For example, the trailer system populates the grid with signal strength values for radar returns associated with the different locations of the grid cells.

Thereafter, the trailer system can analyze the grid to identify radar features that correspond with aspects of the trailer, such as edges, physical features (e.g., tires, reflectors, etc.), and so on. In at least one approach, analyzing the grid to identify the radar features includes identifying patterns associated with the edges, which may include valleys (i.e., reduced signal strengths of returns from just beyond an edge) or peaks (i.e., increased strength of returns from along the edge) that extend linearly in a direction along the grid. The patterns generally correspond to reflected radar signals from underneath the trailer and, thus, areas of reduced signal strength can indicate where the trailer ends whereas areas of increase signal strength can indicate the presence of physical sections of the trailer that may extend downward or otherwise cause greater reflections. Accordingly, the trailer system then determines the trailer size (e.g., length and width) according to locations of the radar features in the grid. The trailer system can then use the trailer size to adjust operation of the towing vehicle by, for example, changing a defined area that a blindspot monitoring system monitors according to, for example, whether the relative velocity of an approaching object will position the object in the defined area within a defined time, adapting stability controls, and so on. In this way, the trailer system improves determinations about trailer size and operation of the vehicle for associated systems.

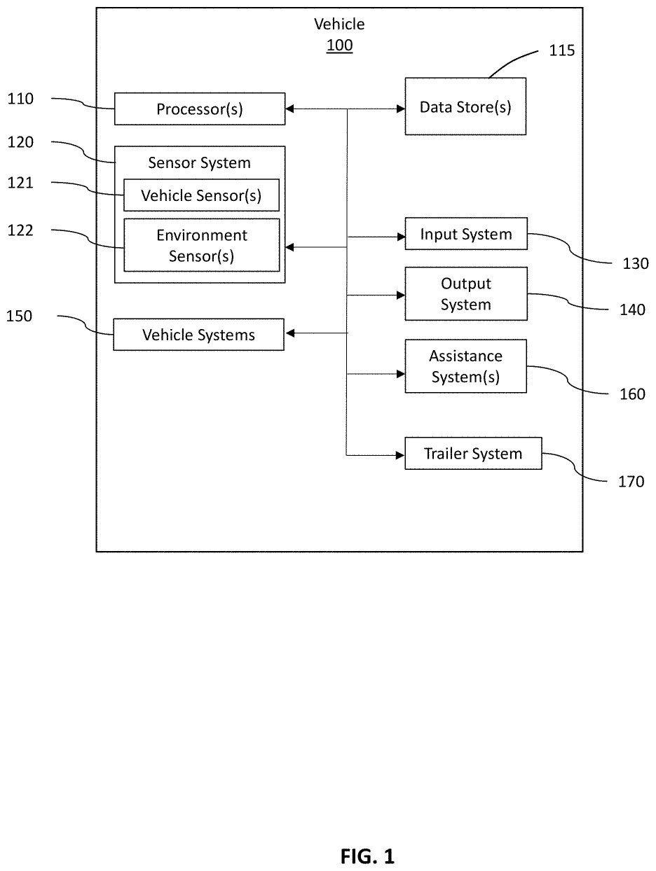

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any form of transport that, for example, tows a trailer, and thus benefits from the functionality discussed herein.

The vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

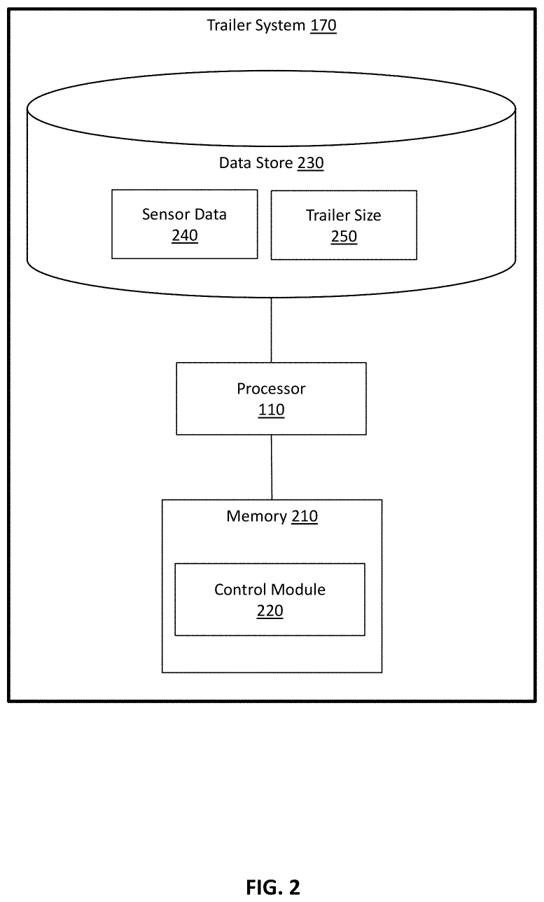

Some of the possible elements of the vehicle 100 are shown in FIG. 1 and will be described along with subsequent figures. A description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In any case, the vehicle 100 (also referred to herein as towing vehicle 100) includes a trailer system 170 that functions to improve operation of the towing vehicle 100 by automatically sensing a size of an attached trailer and adjusting one or more systems in the vehicle 100 according to the presence of the trailer. Moreover, while depicted as a standalone component, in one or more embodiments, the trailer system 170 is integrated with the assistance system 160, or another similar system of the vehicle 100 to facilitate functions of the systems/modules. The noted functions and methods will become more apparent with a further discussion of the figures.

Furthermore, the assistance system 160 may take many different forms but generally provides some form of automated assistance to an operator of the vehicle 100. For example, the assistance system 160 may include various advanced driving assistance system (ADAS) functions, such as a blindspot monitoring, lane-keeping function, adaptive cruise control, collision avoidance, emergency braking, stability control, and so on. In further aspects, the assistance system 160 may be a semi-autonomous or fully autonomous system that can partially or fully control the vehicle 100. Accordingly, the assistance system 160, in whichever form, functions in cooperation with sensors of the sensor system 120 to acquire observations about the surrounding environment from which additional determinations can be derived in order to provide the various functions. Moreover, the trailer system 170, in at least one configuration, may directly adjust or otherwise control the functioning of one or more aspects of the assistance system 160. For example, the trailer system 170 may adjust settings within the assistance system 160 to vary areas being monitored, tolerances, a turn radius, stopping distances, and so on. Further aspects of the relationship between the assistance system 160 and trailer system 170 will be discussed subsequently.

With reference to FIG. 2, one embodiment of the trailer system 170 is further illustrated. As shown, the trailer system 170 includes a processor 110. Accordingly, the processor 110 may be a part of the trailer system 170, or the trailer system 170 may access the processor 110 through a data bus or another communication pathway. In one or more embodiments, the processor 110 is an application-specific integrated circuit that is configured to implement functions associated with a control module 220. More generally, in one or more aspects, the processor 110 is an electronic processor, such as a microprocessor that is capable of performing various functions as described herein when executing encoded functions associated with the trailer system 170.

In one embodiment, the trailer system 170 includes a memory 210 that stores the control module 220. The memory 210 is a random-access memory (RAM), read-only memory (ROM), a hard disk drive, a flash memory, or other suitable memory for storing the module 220. The control module 220 is, for example, computer-readable instructions that, when executed by the processor 110, cause the processor 110 to perform the various functions disclosed herein. While, in one or more embodiments, the module 220 is instructions embodied in the memory 210, in further aspects, the module 220 includes hardware, such as processing components (e.g., controllers), circuits, etc. for independently performing one or more of the noted functions. Thus, the control module 220 may be embodied as instructions within the memory 210 or as a standalone component, such as a system-on-a-chip (SoC), ASIC, or another device.

Furthermore, in one embodiment, the trailer system 170 includes a data store 230. The data store 230 is, in one arrangement, an electronically-based data structure for storing information. For example, in one approach, the data store 230 is a database that is stored in the memory 210 or another suitable medium, and that is configured with routines that can be executed by the processor 110 for analyzing stored data, providing stored data, organizing stored data, and so on. In any case, in one embodiment, the data store 230 stores data used by the control module 220 in executing various functions. In one embodiment, the data store 230 includes sensor data 240 and a trailer size 250 along with, for example, other information that is used by the control module 220.

Accordingly, the control module 220 generally includes instructions that function to control the processor 110 to acquire data inputs from one or more sensors of the vehicle 100 that form the sensor data 240. In general, the sensor data 240 includes information that embodies observations of the surrounding environment of the vehicle 100. The observations of the surrounding environment, in various embodiments, can include surrounding lanes, vehicles, objects, obstacles, etc. that may be present in the lanes, proximate to a roadway, within a parking lot, garage structure, driveway, or another area within which the vehicle 100 is traveling or parked. In particular, the sensor data 240 includes at least radar returns from one or more radars of the towing vehicle 100. The radar is at least one sensor of the environment sensors 122. While the vehicle 100 may have multiple different radars with different fields-of-view (FoV), the vehicle 100, as discussed herein, includes at least one rear facing radar. Thus, the radar may be positioned on a rear surface of the vehicle 100 at corners or in a middle portion of a rear area (e.g., bumper, tail lights, etc.) of the vehicle 100 to provide a FoV of an area behind the vehicle 100 that is generally associated with a trailer. Accordingly, the sensor data 240 may include various observations from different sensors of the vehicle 100 (e.g., rear-facing camera, dynamics data, etc.), but includes at least radar returns from one or more rear-facing radars.

While the control module 220 is discussed as controlling the various sensors to provide the sensor data 240, in one or more embodiments, the control module 220 can employ other techniques to acquire the sensor data 240 that are either active or passive. For example, the control module 220 may passively sniff the sensor data 240 from a stream of electronic information provided by the various sensors to further components within the vehicle 100. Moreover, the control module 220 can undertake various approaches to fuse data from multiple sensors when providing the sensor data 240. Thus, the sensor data 240, in one embodiment, represents a combination of perceptions acquired from multiple sensors and/or other aspects of the vehicle 100.

Furthermore, it should be appreciated that the towing vehicle 100 is connected with a trailer when the noted functions occur. Thus, in one or more arrangements, the trailer system 170 may determine when the towing vehicle 100 connects with a trailer or otherwise identifies the presence of the trailer. For example, in various approaches, the control module 220 may leverage the sensor data 240 to identify through camera images that the trailer is present. Additionally, or alternatively, the sensor data 240 may include information from a trailer hitch sensor that detects when a trailer is attached to the vehicle 100, a braking/lighting system that senses when a trailer is connected, and so on. Accordingly, the connection of the trailer may serve as an initiating event, in one or more arrangements, for the trailer system 170 to determine the alignment for analyzing the sensor data 240. Of course, in further aspects, the trailer system 170 may perform the analysis periodically to determine the presence of the trailer and whether the trailer is aligned without any specific inducing event.

To acquire the sensor data 240 that the control module 220 uses to determine the trailer size 250, the control module 220 first determines whether the sensor data 240 corresponds to observations of the towing vehicle 100 moving in a substantially straight/linear manner. In other words, the control module 220 determines whether the towing vehicle 100 is moving straight and the trailer is aligned with the towing vehicle 100 for the acquired radar returns. The trailer system 170 determines the alignment in order to have specific knowledge about the geometry of the vehicle 100 and the trailer so that inaccuracies are not introduced from unknown angles between the vehicle 100 and the trailer.

In any case, the control module 220 analyzes the sensor data 240 to determine the trailer size 250. In various approaches, the control module 220 initially generates a grid in the area behind the vehicle 100. The grid is an abstraction of the area behind the vehicle that serves as a way to correlate radar returns with different locations. Thus, the trailer system 170 defines the grid according to a longitudinal length and a lateral width relative to the towing vehicle 100. As one example, the width and the length may be based, in part, on a field-of-view of the radar, a range of possible widths and lengths for a trailer, and so on. The grid cells divide the grid into symmetric blocks that the control module 220 populates with the radar returns. The grid cells are, in one example, 0.2 m by 0.2 m. Of course, in further arrangements, the grid cells may be larger or smaller in size. Additionally, one or more rows or columns may be irregular relative to other rows/columns of grid cells. In general, the control module 220 generates the grid as a mechanism for identifying patterns in the returns, and thus may vary in shape/size according to a particular implementation.

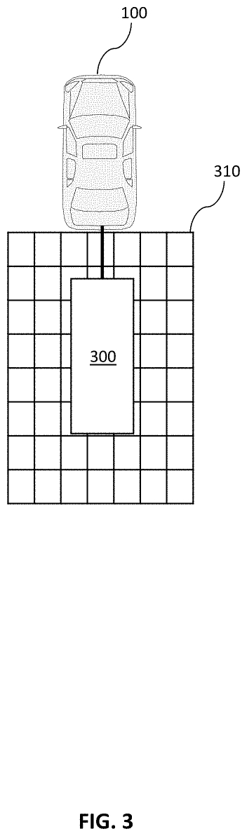

By way of example, FIG. 3 illustrates one configuration of the towing vehicle 100 when towing a trailer 300. As shown in FIG. 3, the control module 220 generates a grid 310 that extends behind the vehicle 100 into an area that generally correlates with a trailer. The grid 310 may vary in size according to a class of the vehicle 100. The trailer system 170 may correlate the grid size with the class because the class generally indicates a maximum size of a trailer that the vehicle 100 may tow. In any case, the control module 220 generates the grid according to a defined length and width and then divides the grid into separate cells. Thus, as the control module 220 receives radar returns from the radar, the control module 220 populates the cells with values of the returns. In general, the radar emits radar signals and acquires the radar returns as the radar signals reflect off surfaces in the environment. In the instance of the vehicle 100 towing a trailer, the radar signals reflect off the underside of the trailer 300 and features of the trailer, such as a bumper, tire, wheel cover, reflector, and other features of the trailer. Moreover, the radar still acquires radar returns from beyond the bounds of the trailer 300.

Accordingly, the control module 220 may acquire the radar returns over a period of time (e.g., 5.0 seconds) and store the values within the grid 310. Thus, the grid serves as a heat map of radar returns from which the control module 220 can identify radar features, which are generally areas of differing characteristics in the radar returns. For example, where the radar returns derive from an edge of the trailer 300, the returns generally exhibit a drop (also referred to as a valley) in power comparative to other returns from under the trailer 300. Moreover, where the radar signals encounter physical features of the trailer 300 extending downward, the radar returns exhibit spikes (i.e., increases) in power. Accordingly, the control module 220 accumulates the radar returns in the grid 310.

Thereafter, the control module 220 analyzes the grid 310 including the radar returns to identify the radar features. The radar features are, for example, patterns within the grid 310 of the radar returns that correspond with characteristics of the trailer 300. For example, the control module 220 analyzes the grid 310 to identify adjacent cells arranged in a linear fashion with reduced strengths to indicate edges of the trailer. Further cues can include peaks at corresponding locations on either side along a linear arrangement of cells with reduced power to indicate placement of wheels. In one arrangement, the control module 220 may define a threshold that indicates a number of cells with similar radar returns in order to indicate an edge. In a further arrangement, the control module 220 may define the threshold to indicate an extent of correlation between the radar returns to identify an edge. For example, the threshold may define an extent of similarity (e.g., 70%) of the values for the radar returns to indicate that they are corresponding.

Once the control module 220 identifies the radar features, the control module 220 can determine the trailer size 250. In one approach, the control module 220 uses the grid 310 to measure distances between the radar features within an area of the trailer 300 as defined by the radar features. In a further approach, the control module 220 may measure distances between the radar features according to known positions of the features. The control module 220 generally determines a length and width of the trailer in determining the trailer size 250 from the radar features of the grid 310.

Upon determining the trailer size 250, the control module 220 can adjust one or more systems of the towing vehicle 100 to operate with the trailer 300 attached. As one example, the control module 220 can adjust monitoring areas for a blindspot monitoring function to extend to an area of the trailer 300. Thus, in one approach, the control module 220 modifies one or more parameters of the assistance system 160 associated with the blindspot monitoring in order to extend the monitored zone to correlate with the trailer size 250. In further aspects, the control module 220 additionally, or alternatively, modifies further functions of the assistance system 160 to account for changes in control due to the presence of the trailer 300. As such, the control module 220 may modify stability control, rear cross traffic detection, collision avoidance, automatic braking, lane keeping, parking assistance, and so on. In this way, the trailer system 170 improves operation of the vehicle 100 while towing a trailer.

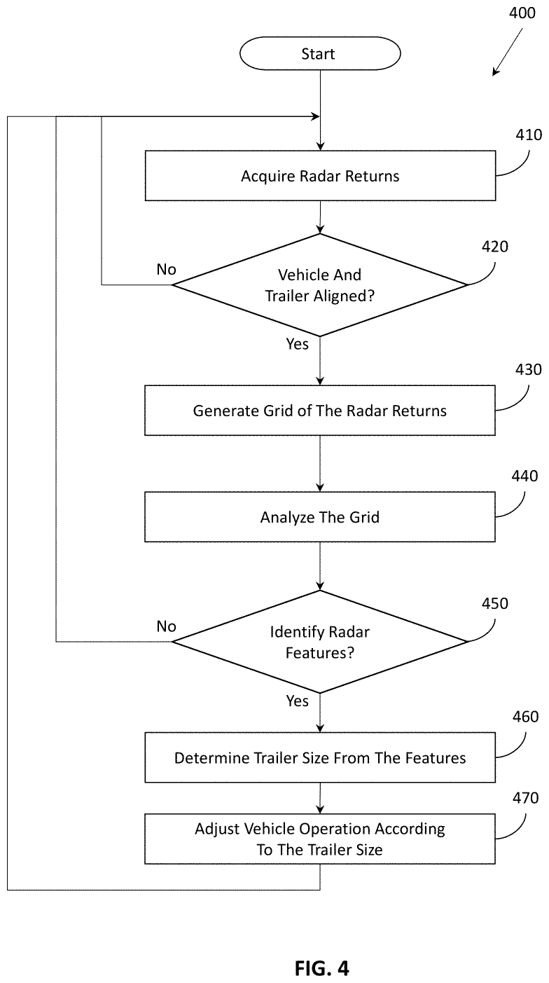

Additional aspects of dynamically determining a trailer size and adapting one or more systems of a vehicle responsive thereto will be discussed in relation to FIG. 4. FIG. 4 illustrates a method 400 associated with determining a trailer size and adjusting vehicle operation. Method 400 will be discussed from the perspective of the trailer system 170 of FIG. 1. While method 400 is discussed in combination with the trailer system 170, it should be appreciated that the method 400 is not limited to being implemented within the trailer system 170 but is instead one example of a system that may implement the method 400.

At 410, the control module 220 acquires the sensor data 240. In one embodiment, acquiring the sensor data 240 includes controlling one or more sensors (e.g., radars) of the vehicle 100 to generate observations about the surrounding environment of the vehicle 100. The control module 220, in one or more implementations, iteratively acquires the sensor data 240 from one or more sensors of the sensor system 120. The sensor data 240 includes observations of a surrounding environment of the subject vehicle 100, including specific regions that are relevant to identifying the trailer size 250. Moreover, the sensor data 240 may further include information about traffic and other hazards that are relevant to the assistance system 160. In any case, the sensor data 240 includes radar returns that provide observations of an area behind the towing vehicle 100 in which a trailer would be present if attached.

At 420, the control module 220 determines whether a trailer is aligned with the towing vehicle 100. In one arrangement, the process of identifying alignment may initially include determining whether the trailer is present or not. As discussed previously, this may include detecting attachment of an electrical connection with a trailer, sensing attachment with a trailer connection sensor, observation via a secondary sensor, such as a camera, and so on.

In any case, the control module 220 further determines when the vehicle 100 and the trailer align so that the sensor data 240 corresponding to a period of alignment can be leveraged for the determination of the trailer size 250. To identify the alignment, the control module 220 can analyze dynamics of the towing vehicle 100 to identify whether the towing vehicle is moving in a substantially straight direction or is turning. In a further aspect, the control module 220 analyzes steering wheel angles over a defined period of time (e.g., 0.5 s) to identify the alignment. Further approaches may also be undertaken, such as using the sensor data 240, which may include images of the trailer, information from a tow hitch angle sensor, and so on. In any case, if the control module 220 determines that the towing vehicle 100 and the trailer do not align, then the control module 220 may repeatedly acquire the sensor data 240 and check until alignment is identified.

At 430, the control module 220 initiates analysis of the radar returns by generating a grid of the area behind the towing vehicle 100. For example, the control module 220 generates rows and columns of the grid over the area in which the trailer may be present. Thus, as previously noted, the control module 220 may consider the class of the vehicle, or extents of possible trailers to determine the overall size of the grid. Once generated, the control module 220 populates the grid with values of the radar returns associated with the area. The values represent signal strengths for returns received from particular areas. Thus, the values correspond with reflections of the radar signals at the positions.

At 440, the control module 220 analyzes radar returns from a radar of the towing vehicle to identify radar features within an area behind the towing vehicle 100. In one arrangement, the control module 220 identifies cells in the grid that correspond with patterns indicative of characteristics of the trailer. The radar features are peaks and valleys in signal strengths of radar returns that correspond with edges of the trailer and parts of the trailer. Thus, the control module 220 identifies, in one approach, neighboring cells with similar or dissimilar radar returns. Where similarities exist, the control module 220 may indicate correspondence. In one approach, similarities are determined according to an extent of correspondence in signal values (e.g., a defined threshold of 70%). Even still, areas of similarities may not be sufficient in some cases to identify radar features associated with the trailer. Thus, in further approaches, the control module 220 may implement further analysis, such as linear regression, machine learning, or another approach to correlate the grid cells.

At 450, the control module 220 determines whether the radar features correlate with the trailer according to patterns in the radar features across the grid. In one configuration, the control module 220 identifies the different radar features and then correlates the features according to, for example, an expected shape of the trailer (e.g., rectangular). Accordingly, features that align with a pattern consistent with the shape of a trailer may be identified as defining the shape of the trailer, and thus the trailer size 250. If the control module 220 determines that the radar features do not sufficiently correspond to indicate the shape of the trailer, then the control module 220 may repeat the process to obtain further radar returns.

At 460, the control module 220 determines the trailer size 250 of the trailer from the radar features. In one arrangement, the control module 220 computes a length and a width of the trailer according to distances of the radar features within the grid. As mentioned, the control module 220 can make direct determinations of distances between the features or may use the grid to derive the distances. In any case, the control module 220 determines both the width and the length of the trailer to provide the trailer size 250.

At 470, the control module 220 adjusts operation of the towing vehicle 100 according to the trailer size 250. In one or more approaches, the control module 220 adjusts an area of a blindspot for the towing vehicle 100 in order to improve the monitoring by a blind spot monitoring system when the trailer is present. The control module 220 may adjust the settings of the blindspot monitoring by adjusting internal configuration parameters of the assistance system 160 of which the blindspot monitoring may be a subfunction. In yet further approaches, the control module 220 provides a command or communication to the assistance system 160 to cause the assistance system 160 to adjust operation according to the trailer. Of course, while a blindspot monitoring system/function is discussed, in further aspects, the control module 220 may adjust the functioning for other functions, including collision avoidance, lane keeping, and so on. In this way, the trailer system 170 improves operation of the towing vehicle 100 when a trailer is present by avoiding potential errors from manual entry by an operator and ensuring that the assistance system 160 can accurately account for the presence of the trailer.

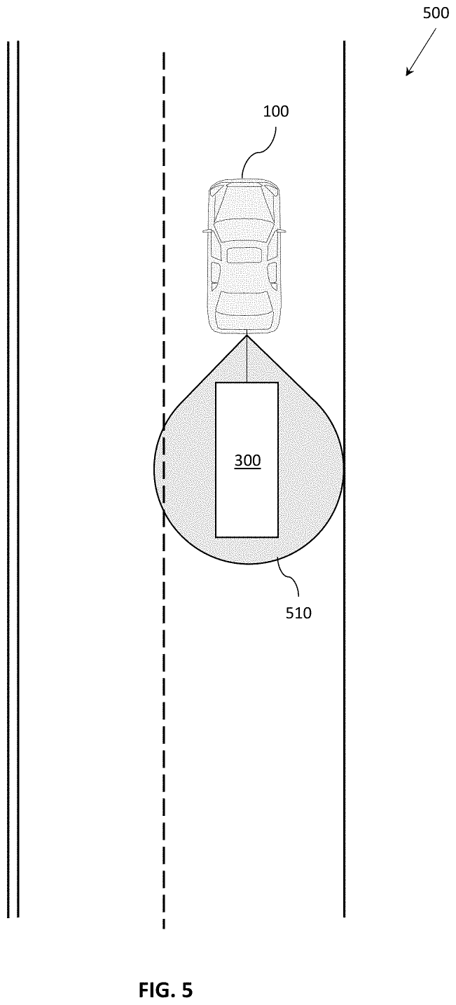

As a further explanation of how the presently disclosed systems and methods function, consider FIG. 5. FIG. 5 illustrates a roadway 500 with the vehicle 100 and the trailer 300 while underway. The vehicle 100, as shown, is substantially aligned with the trailer 300. That is, the trailer 300 is directly behind the vehicle 100 and in a linear configuration without any significant angle therebetween. Moreover, the vehicle 100 uses a radar to generate radar signals that have a FoV 510. FoV 510 generally represents an area observed by the radar when positioned in a rear center location (e.g., within a bumper) of the vehicle 100. Accordingly, the trailer system 170 uses radar returns from the FoV 510 to identify radar features and the trailer size 250.

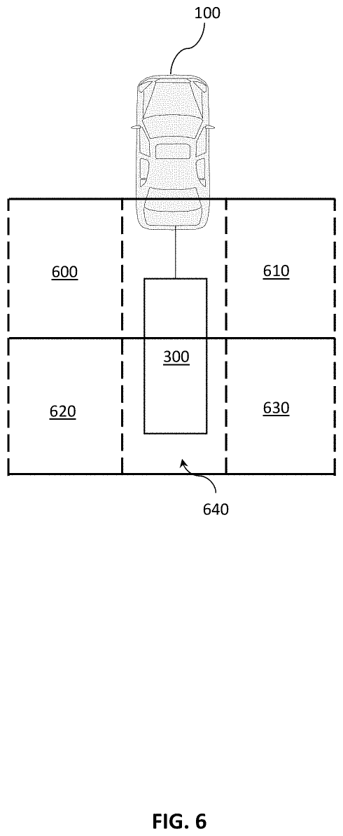

With reference to FIG. 6, the towing vehicle 100 is again illustrated along with monitoring areas for a blindspot monitoring system. As shown, the vehicle 100 may initially monitor areas 600 and 610 when operating without the presence of the trailer 300. However, upon attachment of the trailer 300 and determination of the size, the trailer system 170 may extend the blindspot monitoring to include areas 620 and 630. Similarly, the trailer system 170 may adjust a rear cross-traffic detection area to include an area 640 beyond the trailer 300 instead of an area in which the trailer is present. Beyond adjusting monitoring zones, the trailer system 170 can further adapt operation of the assistance system 160 to account for the trailer size 250 by, for example, adjusting handling and braking aspects, such as braking distances, increased turn radius, and so on. In this way, the trailer system 170 improves operation with a trailer.

Additionally, it should be appreciated that the trailer system 170 from FIG. 1 can be configured in various arrangements with separate integrated circuits and/or electronic chips. In such embodiments, the control module 220 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In further embodiments, portions of the functionality associated with the module 220 may be embodied as firmware executable by a processor and stored in a non-transitory memory. In still further embodiments, the module 220 is integrated as hardware components of the processor 110.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the trailer system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 230) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected” or “communicably connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps.

The one or more data stores 115 can include sensor data (e.g., sensor data 240). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment, such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the trailer system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the trailer system 170, and/or the assistance system 160 may control some or all of these vehicle systems 150 and, thus, may be partially or fully autonomous.

The processor(s) 110, the trailer system 170, and/or the assistance system 160 can be operatively connected to communicate with the various vehicle systems 150 and/or individual components thereof. For example, returning to FIG. 1, the processor(s) 110, the trailer system 170, and/or the assistance system 160 can be in communication to send and/or receive information from the various vehicle systems 150 to control the movement, speed, maneuvering, heading, direction, etc. of the vehicle 100. The processor(s) 110, the trailer system 170, and/or the assistance system 160 may control some or all of these vehicle systems 150.

The processor(s) 110, the trailer system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the trailer system 170, and/or the assistance system 160 can control the direction and/or speed of the vehicle 100. The processor(s) 110, the trailer system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the trailer system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof to responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more modules that form the assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160 either independently or in combination with the trailer system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 240. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A trailer system, comprising:
one or more processors;
a memory communicably coupled to the one or more processors and storing:
a control module including instructions that, when executed by the one or more processors cause the one or more processors to:
responsive to determining that a trailer is aligned with a towing vehicle, analyze radar returns from a radar of the towing vehicle to identify radar features within an area behind the towing vehicle;
determine a trailer size of the trailer from the radar features; and
adjust operation of the towing vehicle according to the trailer size.

2. The trailer system of claim 1, wherein the control module includes instructions to analyze the radar returns including instructions to generate a grid of the area behind the towing vehicle and populating the grid with values of the radar returns associated with the area.

3. The trailer system of claim 1, wherein the control module includes instructions to analyze the radar returns including instructions to identify cells in a grid that correspond with patterns indicative of characteristics of the trailer to identify the radar features.

4. The trailer system of claim 1, wherein the control module includes instructions to determine the trailer size including instructions to determine whether the radar features correlate with the trailer according to patterns in the radar features across a grid that identify at least edges of the trailer.

5. The trailer system of claim 1, wherein the control module includes instructions to determine the trailer size including instructions to compute a length and a width of the trailer according to distances of the radar features within a grid behind the towing vehicle, and
wherein the radar features are peaks and valleys in signal strengths of radar returns that correspond with edges of the trailer and parts of the trailer.

6. The trailer system of claim 1, wherein the control module includes instructions to determine that the trailer is aligned with the towing vehicle including instructions to analyze dynamics of the towing vehicle to identify whether the towing vehicle is moving in a substantially straight direction or is turning.

7. The trailer system of claim 1, wherein the control module includes instructions to adjust the operation of the towing vehicle according to the trailer size including instructions to adjust an area of a blind spot for the towing vehicle for monitoring by a blind spot monitoring system.

8. The trailer system of claim 1, wherein the control module includes instructions to acquire, using at least the radar, the radar returns about the area behind the towing vehicle, and
wherein the radar is located on a rear portion of the towing vehicle and observes an area of the trailer.

9. A non-transitory computer-readable medium storing instructions that, when executed by one or more processors, cause the one or more processors to:
responsive to determining that a trailer is aligned with a towing vehicle, analyze radar returns from a radar of the towing vehicle to identify radar features within an area behind the towing vehicle;
determine a trailer size of the trailer from the radar features; and
adjust operation of the towing vehicle according to the trailer size.

10. The non-transitory computer-readable medium of claim 9, wherein the instructions to analyze the radar returns include instructions to generate a grid of the area behind the towing vehicle and populating the grid with values of the radar returns associated with the area.

11. The non-transitory computer-readable medium of claim 9, wherein the instructions to analyze the radar returns include instructions to identify cells in a grid that correspond with patterns indicative of characteristics of the trailer to identify the radar features.

12. The non-transitory computer-readable medium of claim 9, wherein the instructions to determine the trailer size include instructions to determine whether the radar features correlate with the trailer according to patterns in the radar features across a grid that identify at least edges of the trailer.

13. A method, comprising:
responsive to determining that a trailer is aligned with a towing vehicle, analyzing radar returns from a radar of the towing vehicle to identify radar features within an area behind the towing vehicle;
determining a trailer size of the trailer from the radar features; and
adjusting operation of the towing vehicle according to the trailer size.

14. The method of claim 13, wherein analyzing the radar returns includes generating a grid of the area behind the towing vehicle and populating the grid with values of the radar returns associated with the area.

15. The method of claim 14, wherein analyzing the radar returns includes identifying cells in a grid that correspond with patterns indicative of characteristics of the trailer to identify the radar features.

16. The method of claim 13, wherein determining the trailer size includes determining whether the radar features correlate with the trailer according to patterns in the radar features across a grid that identify at least edges of the trailer.

17. The method of claim 13, wherein determining the trailer size includes computing a length and a width of the trailer according to distances of the radar features within a grid behind the towing vehicle, and
wherein the radar features are peaks and valleys in signal strengths of radar returns that correspond with edges of the trailer and parts of the trailer.

18. The method of claim 13, wherein determining that the trailer is aligned with the towing vehicle includes analyzing dynamics of the towing vehicle to identify whether the towing vehicle is moving in a substantially straight direction or is turning.

19. The method of claim 13, wherein adjusting the operation of the towing vehicle according to the trailer size includes adjusting an area of a blind spot for the towing vehicle for monitoring by a blind spot monitoring system.

20. The method of claim 13, further comprising:
acquiring, using at least the radar, the radar returns about the area behind the towing vehicle,
wherein the radar is located on a rear portion of the towing vehicle and observes an area of the trailer.
